(19) United States
(12) Patent Application Publication
(10) Pub. No.: US 2026/0279222 A1
(43) Pub. Date: Sep. 17, 2026

(54) CONNECTED CARDS

(71) Applicant: Kathryn Leigh Butler Greene, Augusta, GA (US)

(72) Inventor: Kathryn Leigh Butler Greene, Augusta, GA (US)

(21) Appl. No.: 19/078,250

(22) Filed: Mar. 12, 2025

(51) Int. Cl. G09B 17/00; B42D 15/04

(52) U.S. Cl. CPC G09B 17/00; B42D 15/042

(57) ABSTRACT

Implementations of connected cards comprise an elongated piece of material scored along the material to define sections along the material wherein the material is suitable for marking with an erasable marker for reading and wherein the elongated piece of material is weighted on at least one distal end. In some implementations, a method of using the plurality of connected cards comprise writing indicia a plurality of cards, folding the elongated piece of material along the scores to form a stack of connected cards, displaying each card one at a time; erasing at least some of the written indicia; and after using the cards as intended, forming a stack by folding the elongated piece of material along the scores and storing the cards away.

### TECHNICAL FIELD

This disclosure relates to implementations of connected cards and implementations of methods of using connected cards.

### BACKGROUND

Index cards (also referred to as flash cards) are used as a learning tool. For example, “sight words” are typically put on index cards or individual cards to teach high frequency words by showing the cards one at a time to students to test their comprehension skills. However, these individual cards can easily become disorganized during use. After using the individual cards, it can be relatively time consuming to organize these cards.

### BRIEF DESCRIPTION OF THE DRAWINGS

FIG. 1 illustrates an example implementation of a first side of a plurality of connected cards according to the present disclosure.

FIG. 2 illustrates an example implementation of a second side, opposite the first side, of a plurality of connected cards according to the present disclosure.

FIG. 3 illustrates an example implementation of a method of using a plurality of connected cards according to the present disclosure.

FIG. 4 illustrates an example implementation of a method of using a plurality of connected cards according to the present disclosure.

FIG. 5 illustrates an example implementation of a method of using a plurality of connected cards according to the present disclosure.

### DETAILED DESCRIPTION

Implementations of a plurality of connected cards are provided. In some implementations, a plurality of connected card according to the present disclosure comprises an elongated piece of material scored along the material to define sections along the material wherein the material is suitable for marking with an erasable marker for reading and wherein the elongated piece of material is weighted on at least one distal end. In some implementations, the sections are pre-printed with indicia.

In some implementations, a method of using a plurality of connected cards of claim according to the present disclosure comprises writing indicia on a plurality of cards. In some implementations, the method further comprises folding the elongated piece of material along the scores to form a stack of connected cards. In some implementations, the method further comprises displaying each card one at a time in a classroom setting to a plurality of students. In some implementations, the method further comprises erasing at least some of the written indicia. In some implementations, the method further comprises, after using the cards as intended, forming a stack by folding the elongated piece of material along the scores and storing the cards away. In this way, because the “cards” of the elongated piece of material are connected, they cannot be disorganized or lost.

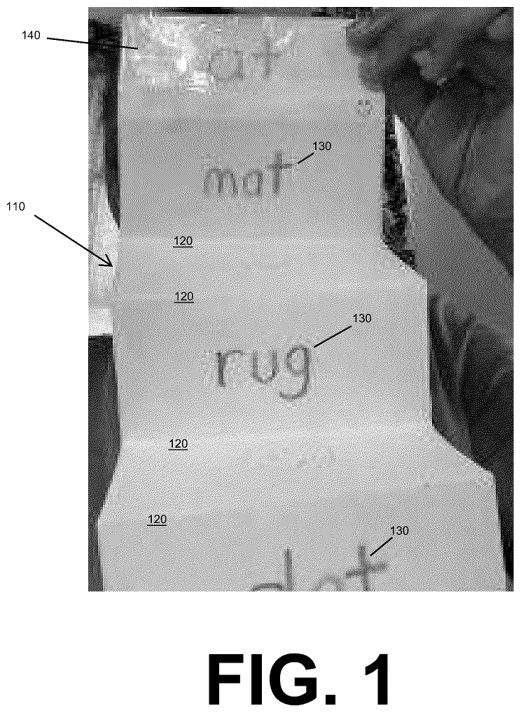

FIG. 1 illustrates an example implementation of a plurality of connected cards 100 according to the present disclosure. In some implementations, the connected cards are made from an elongated piece of material 110 scored 120 along the material to define sections (i.e., cards) 125 along the material for placing indicia 130 comprising words, numbers, or any other indicia. In some implementations, the indicia are educational in nature. In some implementations, the indicia comprise single words. In some implementations, the indicia comprise single math equations.

In some implementations, the material is card stock or any suitable material.

In some implementations, the material is any suitable material on which indicia can be printed or written.

In some implementations the elongated piece of material may be laminated or comprises a layer of a transparent film.

In some implementations, the material may comprise an outer surface suitable for marking with an erasable marker such as a dry erase marker.

In some implementations, the sections 125 are the size of a standard flash card. In some implements, the sections 125 are 3×5 inches or thereabout. In some implementations, the sections 125 are 5×7 inches or thereabout. In some implementations, the sections 125 are the size of a standard index cards. In some implementations, the thickness of the sections 125 are at least 0.011 inches or thereabout.

In some implementations, the elongated piece of material having scores along the material may comprise pre-printed indicia. In some implementations, the elongated piece of material having scores along the material is blank and indicia may be written thereon.

In some implementations, the elongated piece of material is weighted on at least one distal end 140. In some implementations, the elongated piece of material is weighted on both ends. In some implementations, the end(s) may be weighted by adding extra material on a portion of the material at or near the distal end. The end(s) may be weighed by any other suitable means.

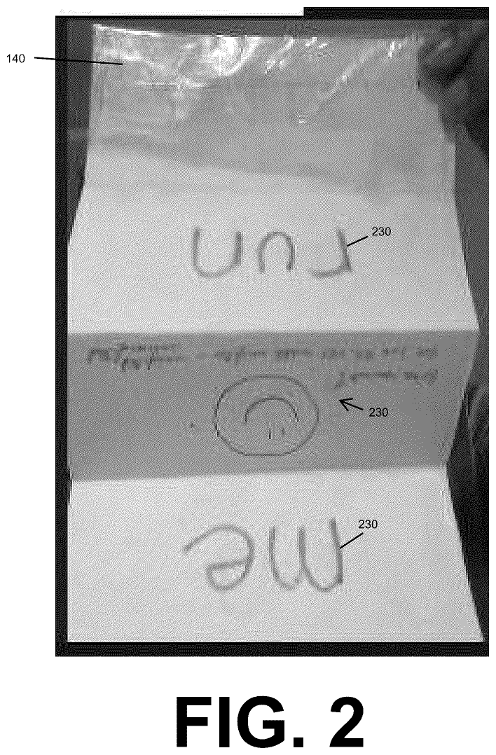

In some implementations, the elongated piece of material is double-sided wherein each side of the elongated piece of material comprises indicia or may be marked with indicia. FIG. 1 illustrates an example implementation of a first side of a plurality of connected cards 100 according to the present disclosure. FIG. 2 illustrates an example implementation of a second side, opposite the first side, of a plurality of connected cards 100 according to the present disclosure. In some implementations, as shown in FIG. 1, the indicia 130 on one side of the elongated piece of material is written in a first orientation and, as shown in FIG. 2, the indicia 230 on the opposite side of the elongated piece of material is written in a second orientation where the first orientation is 180 degrees from the second orientation.

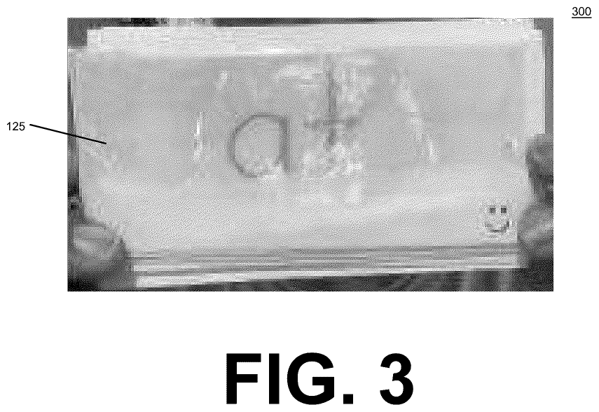

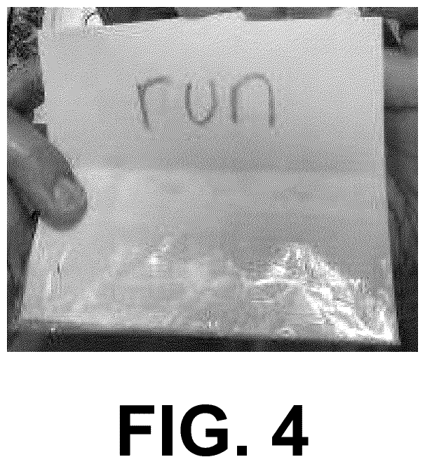

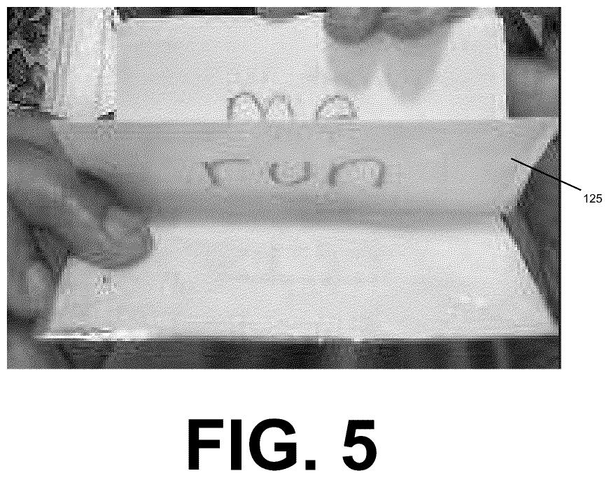

In some implementations, a method of using an elongated piece of material having scores along the material to define cards defined by the scores and having indicia on each card comprises folding the elongated piece of material along the scores to form a stack 300 of connected cards as shown in FIG. 3. The method further comprises displaying each card individually for learning purposes as shown in FIGS. 4 and 5. In this way, the card can be used like flash cards.

In some implementations, the weighted-end(s) aid in displaying the cards individually. In some implementations, the weighted-end(s) aid in the cards folding over one by one even when not assisted by a human. For example, referring to FIG. 5, in some implementations, when a stack 300 is placed on a surface in the orientation shown in FIG. a weighted-end when released to fold downwardly, can initiate the movement of the cards in sequential order to fold over one by one without the assistance of a human.

In some implementations, the method further comprises after using the cards as intended, forming a stack and storing the cards away. In some implementations, the weighted end(s) helps to keep the cards in a stacked formation,

In some implementations, a method of using an elongated piece of material having scores along the material to define cards defined by the scores wherein the cards are blank comprises writing indicia on each card. The method further comprises folding the elongated piece of material along the scores to form a stack of connected cards. The method further comprises displaying each card for learning purposes. The method further comprises erasing at least some of the indicia.

In some implementations, implementations of connected cards according to present disclosure are used in a classroom environment by an instructor to multiple students. In some implementations, implementations of connected cards according to present disclosure are used in an individual setting.

In some implementations, the connected cards may be used as flashcards.

In some implementations, the connected cards may be used as study aids.

In some implementations, the connected cards may be used for recipes.

In some implementations, the connected cards may be used for speaking notes.

In some implementations, the connected cards may be used for note taking.

In some implementations, the connected cards may be used for drawing.

The figures, including photographs and drawings, comprised herewith may represent one or more implementations of the present disclosure.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A plurality of connected cards comprising:
an elongated piece of material scored along the material to define sections along the material wherein the material is suitable for marking with an erasable marker for reading and wherein the elongated piece of material is weighted on at least one distal end.

2. The plurality of connected cards of claim 1 wherein the elongated piece of material is weighted on both distal ends.

3. A plurality of connected cards comprising:
an elongated piece of material scored along the material to define sections along the material wherein the elongated piece of material comprises a first side and a second side opposite the first side, the first side comprises pre-printed indicia on each section written in a first orientation, and the second side comprises pre-printed indicia on each section written in a second orientation wherein the first orientation is different than the second orientation.
the material is suitable for marking with an erasable marker for reading and wherein the elongated piece of material is weighted on at least one distal end.

4. The plurality of connected cards of claim 3 wherein the first orientation is 180 degrees from the second orientation.

5. A method of using the plurality of connected cards of claim 1 comprising:
writing indicia on a plurality of cards;
folding the elongated piece of material along the scores to form a stack of connected cards;
displaying each card one at a time in a classroom setting to a plurality of students;
erasing at least some of the written indicia; and
after using the cards as intended, forming a stack by folding the elongated piece of material along the scores and storing the cards away.

6. A method of using the plurality of connected cards of claim 1 comprising:
writing indicia on a plurality of cards;
folding the elongated piece of material along the scores to form a stack of connected cards;
displaying each card one at a time;
erasing at least some of the written indicia; and
after using the cards as intended, forming a stack by folding the elongated piece of material along the scores and storing the cards away.

7. A method of using the plurality of connected cards of claim 3 comprising:
folding the elongated piece of material along the scores to form a stack of connected cards;
displaying each card one at a time; and
after using the cards as intended, forming a stack by folding the elongated piece of material along the scores and storing the cards away.
